(19) United States
(12) Patent Application Publication
(10) Pub. No.: US 2018/0300717 A1
(43) Pub. Date: Oct. 18, 2018

(54) CRYPTOGRAPHICALLY SECURE TOKEN EXCHANGE

(71) Applicants: ZEESHANUL HAQUE, Kolkata (IN); Rajeev Gangapura Cho Lyer, Bangalore (IN); Rakesh Ramamurthy, Bangalore (IN); Sriram Sethumadhavan, Bangalore (IN)

(72) Inventors: ZEESHANUL HAQUE, Kolkata (IN); Rajeev Gangapura Cho Lyer, Bangalore (IN); Rakesh Ramamurthy, Bangalore (IN); Sriram Sethumadhavan, Bangalore (IN)

(21) Appl. No.: 15/490,463

(22) Filed: Apr. 18, 2017

(51) Int. Cl. G06Q 20/38; H04L 29/06; H04L 9/08; H04L 9/32; G06Q 20/06

(52) U.S. Cl. CPC G06Q 20/3829; H04L 63/0428; H04L 63/0869; G06Q 2220/00; H04L 9/3268; G06Q 20/065; H04L 2209/56; H04L 9/0861

(57) ABSTRACT

A data object is encrypted by an authority and downloaded to a first device. Responsive to a command, the data object may be transferred to a second device and decrypted using a cryptographic key of the authority. A payload extracted from the data object may be executed to change a memory location in the second device after which the data object is deleted from both the first and second devices.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Real time data connections, such as the Internet, have transformed the security of financial transactions by allowing the application of real time substitution of tokens for personal account numbers in addition to tying a token to a specific transaction and payment platform through cryptographic binding. This application of limited use tokens with cryptographic authentication created a new technological platform for processing payments. However, when Internet access is not available, this technological platform is not available and the normally available security advantages must either be abandoned or a transaction denied.

### SUMMARY

In an embodiment, a method of performing a confirmed transfer of a data object or token between a first device and a second device includes receiving the data object from an authority, where the data object represents a denominated value of currency and a payload of the data object is encrypted with a private key of the authority. The method may continue with selecting the data object by the denominated value of the currency via a user interface of the first device, sending the data object from the first device to the second device and receiving a confirmation of receipt of the data object from the second device. The method may conclude by deleting the data object from the first device.

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 is a block diagram of entities participating in a cryptographically secure token exchange;

FIG. 2 is a block diagram illustrating an exemplary data flow for secure token exchange; and

FIG. 3 is a flowchart of a method of performing a secure token exchange between two devices.

### DETAILED DESCRIPTION

The availability of data connections for financial transactions has changed the landscape of payments, whether for e-commerce or secure chip-based in-store transactions. However, many parts of the world lack ubiquitous, always available data connections either wired or wireless. These areas tend to depend on automated teller machines (ATMs) to refill physical wallets in a cash-only economy. Further, in many developing areas even when data networks may be periodically available, the use of electronic wallets or purses, such as Apple Pay, Samsung Pay, etc., may be met with suspicion for several reasons. These may include a general distrust of the process, a desire for anonymous transactions, or participants may simply want to deal in familiar monetary units.

A technology that allows wireless transfers between devices of denominated amounts is discussed and described. The use of denominated amounts mimics a corresponding cash transaction for both adding value to a smart device and for transferring value to another device during a purchase.

The technical features of the participant devices including the combination of biometrics, cryptography, secure wireless networks, and secure memories are illustrated by an exemplary transaction involving value transfer. The transaction is not simply a re-enactment of a cash transaction but is rooted in technology afforded only by technological features available in these physical devices. While the transactions discussed below are illustrated by monetary transactions, the principals involved are the same for many types of data transfers requiring a trusted interaction between unknown parties and could include event tickets, reservations, confirmation of attendance, property titles, or more. Once either or both devices are connected to a network, the transaction can be confirmed.

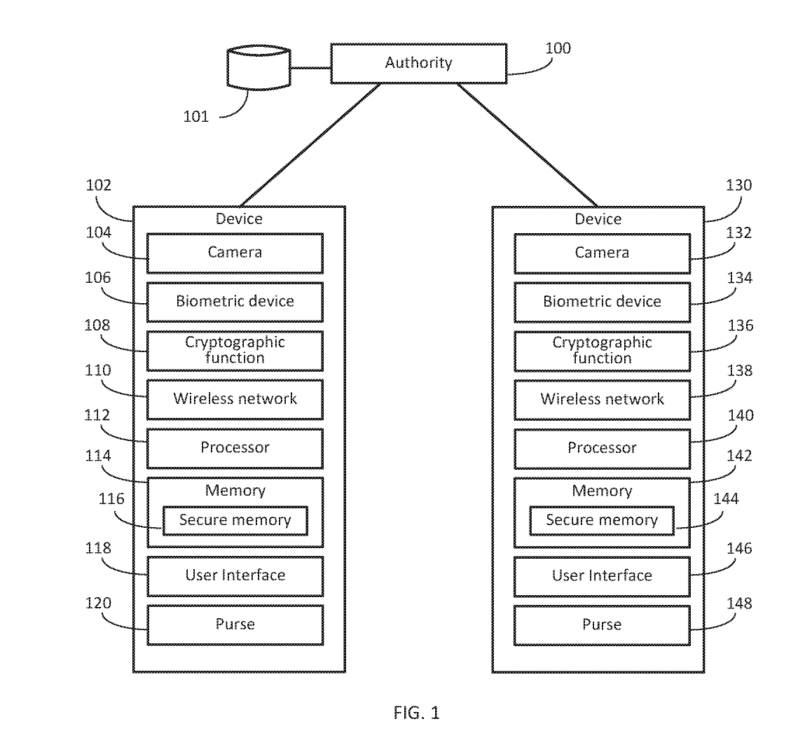

The block diagram of FIG. 1 shows of entities in one embodiment of a cryptographically secure token exchange. In the illustrated embodiment, an authority 100 may be a bank, a payment processor, a certificate authority, or any agency that can issue a signed token, that is, an encrypted data object, and later perform or authorize a settlement associated with the token. In some embodiments, the token and data object may be the same or similar in construction while or in other embodiments the data object may simply be an encrypted representation of value and may not follow a certificate-type format associated with the token elsewhere in this disclosure.

The authority 100 may have access to a database 101 that stores information used to generate tokens and clear transfers between accounts after a settlement is presented. The database 101 may also store data for purse accounts so that the total value in the system and transfers between user accounts can be reconciled.

The authority 100 may be in communication with one or both of a first device 102 and a second device 130. The two devices 102, 130 may be essentially the same and may include a camera 104, 132, a biometric device 106, 134, a cryptographic function 108, 136, and a wireless network device 110, 138. The devices 102, 130 may also include a processor 112, 140 that is functionally coupled to respective memories 114, 142 and user interfaces 118, 146. Each of the memories 114, 142 may include or incorporate a secure memory 116, 144. The secure memories 116, 144 may be part of a secure environment such as a smart chip (not depicted).

For brevity and to reduce complexity, the following discussion is directed to the first device 102 but is equally applicable to the corresponding components of the second device 130. The camera 104 may be capable of capturing images. The images may be part of an authentication process using, for example, facial recognition of a user of the device 102. In another embodiment, such an image may be used for iris recognition for the same purpose. Similarly, the biometric device 106, such as a fingerprint reader, may be used to confirm the identity of a user so that only an authorized user may participate in transferring a token between the devices 102 and 130. The cryptographic function 108 may be a hardware device such as a smart chip that includes both a protected memory 116 as well as key storage and algorithms for encryption, decryption, signing, and signature verification. In other embodiments, the cryptographic function 108 may simply be a software module that performs basic functions such as encryption and signing. While there may be advantages to a hardware implementation of the cryptographic function due to higher security and better tamper resistance, there may be applications in markets where an increased level of security may not justify the added cost and a software implementation of these cryptographic functions may be satisfactory.

The wireless network 110 may allow connectivity between the first device 102 and the second device 130 as well as between the first device 102 and the authority 100. The wireless network 110 may actually include more than one type or protocol. For example connectivity between devices 102 and 130 may be through a short range wireless capabilities which, in an embodiment, may be a near field communication (NFC) protocol that helps to ensure that the token transfer and related communications are performed only between the intended devices and are not at significant risk of eavesdropping or man-in-the-middle attacks by another nearby device. While NFC is a useful communication tool, other wireless, or even wired, connections may be suitable for supporting the required entity-to-entity communication. As discussed more below, even if an NFC protocol is used it may also be desirable to encrypt communications between the two devices 102, 130 using session keys or other techniques.

The processor 112 may be any processor or system-on-chip capable of supporting functions of the device 102. In an embodiment, the processor may be a Snapdragon chip available from Qualcomm Technologies, Inc. Other processors may be used based on the design of the device 102. The memory 114 may be a combination of volatile and nonvolatile physical memory devices and may include RAM, ROM, flash memories, removable media, and in some devices, rotating media. The memory 114 does not include carrier wave or propagated media type memories. The secure memory 116 may be a partition of the main memory 114 or as discussed above may be part of a separate cryptographic device 108. In an embodiment, the secure memory 116 may only updatable after an authentication process so that items stored in the secure memory 116 are protected from being created, deleted, and in the case of secure keys, from being directly read. That is, secure keys may be used in a cryptographic process but may not be readable by an outside request.

The user interface 118 may include a display which may be a touchscreen and may have various mechanical keys as well as a soft keyboard embodied on the touchscreen. In an embodiment, the device 130 is substantially the same as the device 102 having the same or similar components with the same or similar functions. It is expected that the transfer of tokens described below is symmetric and may be performed in either direction, that is from the device 102 to the device 130 and also from the device 130 to the device 102.

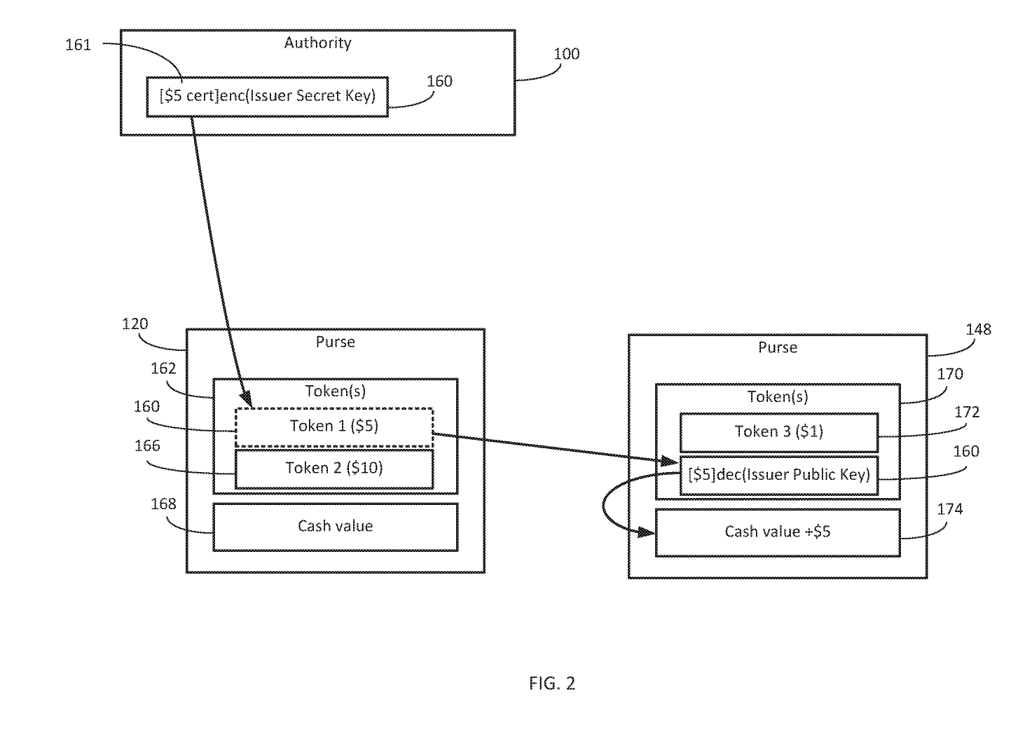

A purse 120 of the device 102 and a purse 148 of the device 130 may be a physical or a logical construct that stores value. An exemplary architecture of the purse 120 is discussed more below with respect to FIG. 2. In the case of a physical construct, the purse 120 may be implemented in a smart chip or other secure memory so that a memory location associated with the purse 120 is securely updated with a number that reflects the value stored and available at the local purse 120. When implemented as a logical construct, the purse 120 may be a simple memory location that stores a token that is generated by a cryptographic function 108 as part of a purse update transaction. In this embodiment, in order to update the value of the purse a cryptographic operation, such as encryption with the authority public key may be performed and the newly generated encrypted value stored in the identified memory. To summarize, the purse 120 may store two kinds of value. The first, tokens, represent spendable value that may be used in a transaction with another device 130. The second, stored cash value, represents value converted from a token. The stored cash value may only be redeemed through interactions with the authority 100.

In a particular embodiment, value of the purse 120 may only be decreased, that is redeemed, in a transaction with the authority 100. Value may be added to a purse 120 through the use of a token processing step to extract value from a token received at a device, for example device 102. However, tokens may not be created at a device 102 using value from a respective purse 120. Tokens are received from the authority 100 based on a purchase transaction between the device owner and the authority 100 either by using existing value of a purse 120 or by an out of band transaction such as an in-person visit to the authority 100 or via an application that sponsors such an interaction with the authority 100 by an account holder.

In an embodiment, the purses 120 may be periodically synchronized with their corresponding accounts in the database 101 either via a mobile data connection (e.g., 3G or 4G) , a WiFi connection, or an SMS message. Because the data required for synchronization may be limited, for example having only a purse value, new transaction value(s), and unspent tokens, a single SMS message from the device 102, 130 to the authority 100 may be sufficient to support the synchronization process. A response message from the authority 100 to the device 102 may contain an encrypted key that is used to extend an expiration date on the purse 120 and any stored tokens. When the expiration date is reached, that is, that too long of a time has passed since a synchronization, the purse 120 and any unused tokens may be locked to help prevent fraud. After being locked, in one embodiment, the device 102 may be required to connect via a wireless data connection, or even be presented at an issuer-specified location for confirmation of identity before the purse 120 is unlocked.

In operation, referring to FIG. 2, the device 102 requests a token 160 from the authority 100 using either value from the purse 120 or from an account held at or accessible by the authority 100. The token 160 may be encrypted with a private key of the authority 100. The token 160 may also be or include a PKI certificate 161 that includes a public key of the authority as well as data that can be used to check the certificate's validity. In an embodiment, the token 160 may be in denominations that match the local currency. For example, in the United States, the tokens may be available in 1, 5, 10, and 20 dollar denominations. The purses 120, 148 may have respective token vaults 162, 170. As illustrated, the purse 120 may already have a token 166 with a value of $10 and the purse 148 may have a token 172 in a $1 denomination. During a transaction, the token 160 may be transferred from a purse 120 of the first device 102 to the token vault 170 of the second device 130. The purse 120 may include a cash vault 168 with an existing cash value. The second device 130 may decrypt and process the token 160 to add the denominational value of $5 to any existing cash value in the cash vault 174. If “change” is required for the transaction, the second device 130 may transfer a lower denomination token back to the first device 102 to complete the transaction.

The cash vaults 168 and 174 are not available to the user for performing transactions. The cash vaults 168 and 174 are only redeemable by the authority 100. In an embodiment, where no secure element is present on a device 102, the value added to the purse 120 may be encrypted with a public key of the authority 100 so that only the authority 100 can redeem the purse. In an embodiment, the token 160 itself may be re-encrypted with the authority public key so that an audit trail may be established. A second counter may be maintained in the mobile application or elsewhere so that the user can see the purse value and confirm that a recent transaction has completed and the internal purse value has been updated. When a secure element is present on the device 102, different techniques for protecting the value may be available, including signing transactions with a derived key shared with the authority 100.

The token processing may occur in applications running on each device so that the transaction is atomic. That is, the transaction either fully completes or fully fails so that an attack such as one in the form of a well-timed interruption in communication does not allow the receiving device to process the token while the sending device rolls back the transaction and retains the token as well.

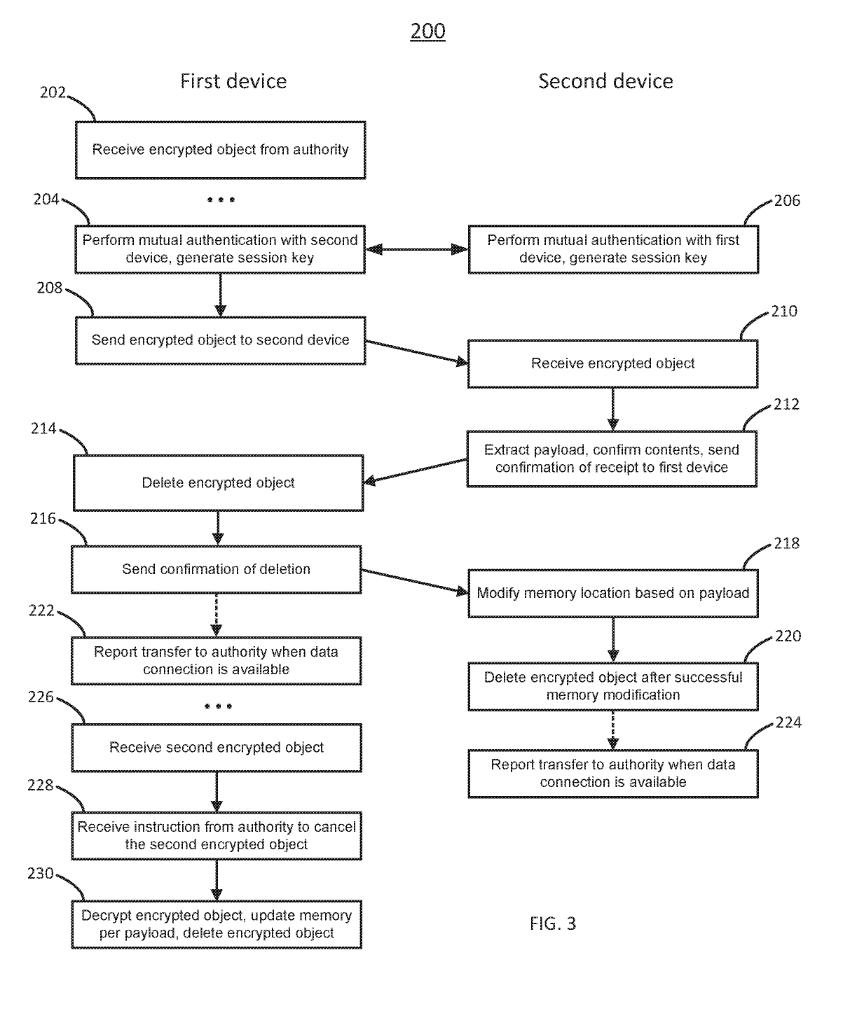

FIG. 3 is a flowchart of a method 200 of delivering a token from a first device 102 to a second device 130. At block 202, the first device may receive the token, from an authority 100 where the token contains a payload. The token may have a cash value of a predetermined denomination set by the authority 100. In various embodiments, the payload may simply be data that is stored in a secure memory 116, 144, or may be executable code that causes the processor to perform a function that increases the value of the purse 120,148 of the device that processes the token. Other combinations of data and executable code may be supported in other embodiments. Because the token is encrypted, for example, with a private key of the authority 100, the token may be stored in the regular memory 114. Although, given its monetary value, it may be stored in the secure memory 116 to reduce the risk of accidental deletion.

The token 160 may be stored at the first device 102 for an indefinite period of time. There are several ways the token 160 can be converted to value. In one case, in response to a user's input, the token is transferred to another device 130 as described. In another embodiment, in response to a fraud threat or if the user indicates the device has been lost or stolen, the authority 100 may push a message to the purse 120 that converts any stored tokens to cash values in the cash vault 168. Because the purse cash value is only redeemable at the authority 100, an attempt to convert the cash value may be detected. The use of biometric authentication prior to initiating a transaction may be helpful to reduce risk of loss when there is no network access to receive such a cancellation message from the authority 100.

At block 204 for the first device 102 and at block 206 of the second device 130, a mutual authentication may be performed between the first device 102 and the second device 130. The mutual authentication may use any of several processes for mutual authentication, including but not limited to, exchange of nonces, verification of credentials, and derivation of session keys. Verification of credentials and generation of session keys may use locally held master keys, e.g. symmetric keys owned by the authority 100 and installed during a personalization process or mutual authentication using a PKI verification process. These exemplary mutual authentication and session key generation processes may use a nonce or random number to help prevent a replay attack of the session. The session keys, if used, may be used to encrypt all data subsequently transferred between the first device 102 and second device 130, even the token which may itself already be encrypted.

At block 208, a copy of the token may be sent from the first device 102 to the second device 130, for example via a wireless connection such as Bluetooth or near field communication (NFC) protocol. WiFi, Zigbee, or any of a number of other wireless connections may be used, but if higher power implementations of these networks are used, the associated longer range of the connection may increase the risk of eavesdropping.

The second device 130 may decrypt, at block 210, the token using a key provided by the authority 100, such as derived master key or a public key associated with a private key of the authority 100. In an embodiment, the token may be or include a certificate, such as an X.509 compliant certificate that includes the public key of the authority 100 and/or a confirmation reference. At block 212, the second device 130 may confirm the payload, for example, by the use of a simple checksum or by comparing some or all of the payload to a known, expected value. When the confirmation is completed, the second device 130 may send a confirmation of receipt of the token and/or payload to the first device 102.

At block 214, responsive to receipt of the confirmation from the second device 130, the first device 102 may delete the token from its memory 114, or in an embodiment, from the secure memory 116. The first device 102 may then send to the second device 130 a confirmation of the deletion of the token at block 216.

When the confirmation of deletion is received at the second device 130, at block 218, a memory location at the second device 130 may be modified according to the contents of the payload. That is, in one embodiment an application in the second device 130 uses the payload as a data reference to update a memory location in the second device 130, such as a value in the purse 148. In another embodiment, the payload may include executable code that is executed to cause the desired changes to the memory location to be updated. In the illustrated embodiment, the modification of the memory location adds the cash value associated with the payload to the cash balance of the purse 148. In such an embodiment, since the offline transaction is limited to adding values to each device's local purse 120, 148, and redemption (cashing out) of the purse may only be through an online transaction with the authority 100, a control point is established. This allows each one-way transaction to be audited, even in embodiments where the transaction between the first device 102 and the second device 130 is anonymous. In this way, runaway value increases in the ecosystem may be checked at an early point. As discussed above, the payload may include executable code that causes the second device 130 to modify the contents of the memory location. The memory location may be a protected or secure memory 144 that requires authentication prior to permitting modification. In an embodiment, the payload may have data that contributes to the authentication process for updating the secure memory 144.

At block 220, the token may be deleted from the second device 130 after the modification of the memory location at the second device 130 according to the contents of the payload.

In an embodiment, each step, such as the transfer, the purse value add process, and the respective deletions of the token at each device 102 and 130 may be recorded in a ledger and signed with a secret or private key of device performing the action. That is, the first device 102 may add to the ledger for actions taken at the first device 102 and the second device 130 may add to the ledger for actions taken performed by the second device 130. The secret or private key may be a PKI private key so that the ledger can be freely read by any party with the respective public keys. In another embodiment, the private key may be a shared secret key held between device 102 and the authority 100 and separately between the device 130 and the authority 100, so that each device can view its own transactions but only the authority 100 can review the full ledger. The ledger may be passed between the devices each time a communication occurs so that in the case illustrated above, the ledger would be initiated at block 208 by the first device 102 and added to at blocks 212, 214, 218, and 220 by having the respective device encrypt the transaction in its current state, for example, by encrypting the actual data passed between the devices 102 and 130. The ledger may be passed to the authority 100 when redeeming the purse value so that the authority 100 can trace the token from issue through to redemption. However, the use of a ledger is not required, for example, in a fully anonymous system.

A second token may be sent from the second device 130 to the first device 102. In one embodiment the transfer may be to refund an overpayment (i.e. to provide change) made by the original transfer of the token from the first device 102 to the second device 130, in which case, the second token may have a lower cash value of a second predetermined denomination set by the authority 100. In another embodiment, the second transfer may be unrelated to the first transfer from the original transaction. That is to say that the transfer process between devices is symmetric and works in either direction. The number of transactions each device 102, 130 can support is only limited by the number of tokens stored at each device. In a “change back” transaction, the original session may be maintained and the existing session keys used for the reverse transfer of the second token. However, in some embodiments, each transfer may require establishing a new session between the devices 102 and 130.

In an exemplary transaction, a buyer, holding device 102 may approach a seller, holding device 130. A purchase transaction may be negotiated and an amount agreed upon, for example, $28. The first device 102 may then be instructed to send the second device 130 a $20 token and a $10 token. The second device 130 may send two $1 tokens back to the first device 102.

At block 222, a data connection may be established between the first device 102 and the authority 100 subsequent to the transfer and deletion of the token. The data connection may be used, among other things, to send a confirmation of the transfer and deletion to the authority 100. Similarly, at block 224, the second device may establish a data connection with the authority 100 sometime after the end of the process to send a confirmation of the receipt of the token, the value add, and the deletion of the token. The activities at both blocks 222 and 224 may be at virtually any time after the original transaction, but may most likely occur during either a reloading of new tokens or a redemption of purse values.

At block 226, the first device may receive a second token from the authority 100 as part of a normal reload process. However, in the event that the first device 102 is lost or stolen, the owner may contact the authority 100 and the authority 100 may send a cancellation message at block 228 to the first device 102 with an instruction to cancel all tokens. Such a message may be sent via a text message or a push alert to an application on the first device 102. At block 230, the first device 102 may process the second token and any other stored tokens as if it had just been received from another device in a transaction and without any notice to or action from a user of the device. That is, the first device 102 may decrypt the token and add its value to the purse 120 by adjusting the appropriate memory location. This effectively disables the use of the first device 102 from offline transactions because the purse 120 can only be redeemed by the authority 100, which is aware that the purse 120 has been compromised.

In embodiments that use a ledger, the ledger provides an audit trail for spent tokens. As well, the authority 100 has a record of purchased values, so that the account owner may have recourse to recover tokens lost via a stolen device 102 or fraudulent transaction. In a further step, a certificate revocation list can be kept for lost or compromised tokens and pushed to other participants as they have data connections. These users may then be able to check even if offline as to the validity of a token as it is presented to further limit the exposure of the authority 100 or a device owner to a loss.

In order to limit exposure to a compromise of the system, a limit on transactions in a given time frame may be enforced. For example, in one embodiment, token transfers may be limited to 10 per day. In another embodiment, the limit may be value based, such as imposing a limit of $100 per day. Other limits using other values and time frames may be implemented based on local requirements and customs, as well as on a user-by-user basis at the discretion of the authority 100. Further, each token 160 may have an expiration date that causes the token to automatically expire after a certain amount of time, for example, 6 months. At that time, the value of the token 160 may be converted to cash in the cash vault 168, 174 as discussed above. In another embodiment, a special transaction with the authority 100 may be required to re-authorize the token 160. In embodiments where the token is in the form of a certificate 161, such as an X.509 certificate, the expiration of the token 160 use or be tied to an expiration of the certificate 161.

A technical effect of a system and method in accordance with the current disclosure is the use of secure memories and signed, tokens that carry the data or code necessary to allow changes to purse values in a cashless ecosystem. In another embodiment, a technical effect is the use of add-only offline processing of the purse so that redemptions can only be made online with an authority 100 to reduce the risk of fraudulent transactions. In this embodiment, no local secure elements are required for offline transactions to be performed.

A system and method in accordance with the current disclosure benefits both sellers and buyers in rural or undeveloped areas by allowing cashless transactions in an offline environment. Buyers and sellers are no longer burdened with carrying large amounts of cash that can be lost or stolen with the associated frequent trips to an automated teller machine or bank. Even periodic access to a data connection may allow recharges and redemptions at a convenient time without the need for data access in real time during a transaction. Lost or stolen devices may have their stored values cashed out and protected via a much more ubiquitous connection type such as an SMS (text) message carried on a voice-channel connection.

The figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of delivering a token from a first device to a second device, the method comprising;
receiving, at the first device the token from an authority, the token containing a payload;
sending a copy of the token from the first device to the second device;
decrypting, at the second device, the token using a key provided by the authority and confirming the payload;
sending, from the second device to the first device, a confirmation of the payload;
deleting the token from the first device responsive to receipt of the confirmation of the payload;
sending, from the first device to the second device, a confirmation of the deletion of the token from the first device; and
modifying a memory location at the second device according to a content of the payload.

2. The method of claim 1, further comprising limiting sending the copy of the token by one of a number per time unit and a total value per time unit.

3. The method of claim 1, further comprising, performing a mutual authentication between the first device and the second device.

4. The method of claim 3, further comprising, generating, after the mutual authentication, a session key used to encrypt data subsequently transferred between the first device and second device.

5. The method of claim 1, further comprising generating a cryptographically protected ledger for each data transfer between the first device and the second device beginning with sending the copy of the token from the first device to the second device.

6. The method of claim 1, further comprising deleting the token from the second device after modifying the memory location at the second device according to the content of the payload.

7. The method of claim 1, wherein the content of the payload includes executable code that cause the second device to modify the contents of the memory location.

8. The method of claim 1, wherein the token expires after a predetermined time period.

9. The method of claim 1, further comprising:
establishing a data connection between the first device and the authority subsequent to transferring the token to the second device and deleting the token from the first device; and
sending a confirmation of the transfer and deletion to the authority.

10. The method of claim 1, further comprising:
establishing a data connection between the second device and the authority subsequent to receiving the token, decrypting the token, modifying the memory location, and deleting the token; and
sending a confirmation of the receipt of the token and the deletion of the token to the authority.

11. The method of claim 1, wherein the memory location is a cash balance of a local purse.

12. The method of claim 11, wherein the token has a cash value of a predetermined denomination set by the authority.

13. The method of claim 12, wherein modifying the memory location comprises adding the cash value to the cash balance of the local purse.

14. The method of claim 13, further comprising, sending a second token from the second device to the first device to refund an overpayment made by the sending of the token from the first device to the second device, the second token having a lower cash value of a second predetermined denomination set by the authority.

15. The method of claim 1, further comprising:
receiving a second token from the authority;
receiving an instruction from the authority to cancel the second token;
decrypting the second token to extract a second payload; and
adjusting a memory location in the first device according to a content of the second payload.

16. A system for exchanging tokens between a first device and a second device, the system comprising:
the first device having a processor coupled to a memory, a wireless network device, a user interface, and a cryptographic function, the memory storing instructions that cause the processor to:
receive a token from an authority;
storing the token in the memory;
transfer the token to a second device responsive to an instruction received via the user interface; and
delete the token from the memory responsive to a confirmation of receipt of the token from the second device; and
the second device having a second processor, second memory, second wireless connectivity, a second user interface, and a second cryptographic function, the second memory storing instructions that cause the second processor to:
receive the token from the first device;
store the token in the second memory;
send a confirmation of receipt of the token to the first device;
decrypt the token to extract a payload;
execute a command based on the payload; and
delete the token from the second memory responsive to executing the command based on the payload.

17. The system of claim 16, wherein the memory stores additional instructions that cause the processor to:
receive an additional token;
store the additional token in the memory;
receive an instruction from the authority to cancel the additional token;
decrypt the additional token to extract a payload;
add an amount designated in payload to a local purse; and
delete the additional token from the memory.

18. A method of performing a confirmed transfer of a data object between a first device and a second device, the method comprising:
receiving the data object from an authority, the data object representing a denominated value of currency, a payload of the data object encrypted with a private key of the authority;
selecting the data object by the denominated value of the currency via a user interface of the first device;
sending the data object from the first device to the second device;
receiving a confirmation of receipt of the data object from the second device; and
deleting the data object from the first device.

19. The method of claim 18, wherein the data object is formatted according to a standard digital certificate including a public key, an expiration date, and a certificate authority reference.

20. The method of claim 18, further comprising:
receiving, at the first device, a second data object from the second device;
validating the data object using a locally stored certificate issued by a certificate authority;
decrypting a payload of the second data object using a public key contained locally stored certificate, the decrypted payload representing a denominated cash value;
adding the denominated cash value to a local purse account of the first device; and
deleting the second data object responsive to adding the denominated cash value.
